(19) United States
(12) Patent Application Publication
(10) Pub. No.: US 2009/0248585 A1
(43) Pub. Date: Oct. 1, 2009

(54) ONLINE FIXED-POSITION ADVERTISEMENT RESERVATION AT FIXED PRICE AND DURATION

(75) Inventors: Sammy Hsieh, Hong Kong (CN); Jiatong Li, Hong Kong (CN)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/059,462

(22) Filed: Mar. 31, 2008

(51) Int. Cl. G06Q 30/00; G06Q 10/00

(52) U.S. Cl. 705/80; 705/14

(57) ABSTRACT

A method for reservation of sponsored search listing positions, including extending an offer to advertisers to purchase a fixed sponsored search listing position on a search results web page affiliated with a keyword, wherein a location of the fixed position is guaranteed to the advertisers for a fixed fee over a fixed duration during which the position will belong to a purchasing advertiser; reserving the fixed position related to the keyword for the fixed duration for an advertiser; receiving an advertisement from the advertiser to be positioned in the fixed position; storing the advertisement in a database; and serving the advertisement to the fixed position of the search results web page in response to a search query for the keyword each time the search query is executed for the keyword over a time period of the fixed duration.

### BACKGROUND

1. Technical Field

The disclosed embodiments relate to systems and methods for reserving sponsored listing positions, and more specifically, for reserving the sponsored listing positions in a fixed position on a web page for a fixed price over a pre-defined or fixed duration of time.

2. Related Art

Internet advertising is a multi-billion dollar industry and is growing at double digits rates in recent years. It is also the major revenue source for internet companies, such as Yahoo!® or Google®, which provide advertising networks that connect advertisers, publishers, and Internet users. As an intermediary, these companies are also referred to as advertiser brokers. New and creative ways to attract users' attention to advertisements or to the sponsors of those advertisements help to grow the effectiveness of online advertising, and thus increases the growth of sponsored advertising. Publishers partner with advertisers, or allow advertisements to be delivered to their web pages, to help pay for the published content, or for other marketing reasons.

Many advertisers, however, find it difficult to compete in the most common way of paying for a listed advertisement: pay-per-click (PPC). The advertiser obtains a rank position for an advertisement through bidding on a related PPC term or keyword, which rank may change over time as demand for the keyword may fluctuate in certain markets. The rank position of the advertisement usually has a direct correlation with a number of clicks from the consuming public on the advertisement, wherein the higher ranked it is, the greater amount of browsing traffic is attracted. If an advertiser pays a publisher or advertiser broker (such as Yahoo!, of Sunnyvale, Calif.) for each click on his or her advertisement, the advertiser may be subject to increasing or unpredictable costs. Continual monitoring of the bidding market is required for the advertiser to track return on investment (ROI) according to the advertiser's budget.

Most small business owners have strict budgets, and therefore, even small fluctuations in the online advertising markets may strain a budget. If this is compounded over numerous keyword search terms, the result could be devastating for a small business. Tracking ROI on dozens of terms could also tax the resources of a small or home-based business to the point that the best option is to scale back on the number of PPC terms owned. This may save the budget, but this option does not satisfy the growing need for the small business owner (or any business owner) to affordably advertise to its target market. Use of pay-per-click advertising may be especially inappropriate for bidding on “tail terms,” or low-cost, low-volume terms that are typically less demanded in general, and that are highly targeted for a given advertiser's business. This is because tail terms may be quite valuable to the advertiser, but because of the low demand, may be obtainable through PPC bidding for a cost far below its actual, or a realistic, market value to the advertiser.

### SUMMARY

By way of introduction, the embodiments described below are drawn to systems and methods for reserving sponsored listing positions, and more specifically, for reserving the sponsored listing positions in a fixed position on a web page for a fixed price over a pre-defined or fixed duration of time

In a first aspect, a method is disclosed for reserving sponsored listing positions, including extending an offer to advertisers to purchase a fixed sponsored search listing position on a search results web page affiliated with a keyword, wherein a location of the fixed position is guaranteed to the advertisers for a fixed fee over a fixed duration during which the position will belong to a purchasing advertiser; reserving the fixed position related to the keyword for the fixed duration for an advertiser; receiving an advertisement from the advertiser to be positioned in the fixed position; storing the advertisement in a database; and serving the advertisement to the fixed position of the search results web page in response to a search query for the keyword each time the search query is executed for the keyword over a time period of the fixed duration.

In a second aspect, a method is disclosed for reserving sponsored listing positions, including extending an offer to advertisers to purchase a predetermined number of fixed sponsored search listing positions on a search results web page affiliated with a keyword, wherein a location of each fixed position is guaranteed to the advertisers for a fixed fee over a pre-defined duration during which each position belongs to purchasing advertisers; reserving the fixed position related to the keyword for the fixed duration for an advertiser upon acceptance of the offer by the advertiser; receiving an advertisement from the advertiser to be positioned in the fixed position; and providing a call-back feature associated with the advertisement of at least a highest-ranked fixed position, wherein upon a user engaging the feature, causing a pop-up window in the web page to accept a contact phone number from the user for the advertiser to call as a way to follow up on a lead provided by the user.

In a third aspect, a method is disclosed for reserving sponsored listing positions, including receiving a request from advertisers to purchase a fixed sponsored listing position within search listing categories for a pre-defined duration of time and a flat fee, wherein a plurality of related keywords are associated with each category, and wherein a plurality of fixed positions are available for each category; checking availability of a fixed position within a category for an interested advertiser; reserving the fixed position for the category, if available, for the advertiser for the pre-defined duration of time upon acceptance of the offer by the advertiser; receiving an advertisement from the advertiser to be located in the fixed position for each of at least some of the plurality of keywords; storing the advertisements in a database; and serving an advertisement to the fixed position on a search results web page in response to a search query for a keyword of the plurality of keywords each time the search query is executed during the duration of time.

In a fourth aspect, a method is disclosed for reserving sponsored listing positions, including receiving a request from advertisers to purchase a predetermined number of fixed advertisement positions available in conjunction with content match on a published web page for a fixed fee and for a pre-defined duration of time, wherein content match is the service of sponsored advertisements to a published web page related to the content of the published web page; checking position availability for a fixed position affiliated with desired content by an interested advertiser; reserving an available, fixed position related to content of interest to the advertiser for the pre-defined duration of time; receiving an advertisement from the advertiser to be positioned in the fixed position; storing the advertisement in a database; and serving the advertisement to the fixed position on the published web page containing related content each time a user browses to the published web page during the pre-defined duration of time.

In a fifth aspect, a method is disclosed for serving sponsored advertisements together with fixed-position advertisements, including receiving data from an advertising server including a list of fixed-position, fixed-price, and fixed-duration sponsored advertisements reserved by advertisers for a given keyword, category of keywords, or combinations thereof; aggregating the list of fixed-position advertisements together with a plurality of sponsored search advertisements for the keyword, category of keywords, or combinations thereof such that the fixed-position advertisements will be served to the correct fixed positions among a plurality of sponsored search positions; receiving a query from a user for one of the keywords; and serving to a search results web page of the user the plurality of fixed-position sponsored advertisements to their respective fixed positions, and the plurality of search sponsored advertisements to one or more remaining available sponsored search positions.

In a sixth aspect, a system is disclosed for reserving sponsored listing positions, including a fixed position offeror operable to extend an offer to advertisers to purchase a fixed sponsored search listing position on a search results web page affiliated with a keyword. A location of the fixed position is guaranteed to the advertisers for a fixed fee over a pre-defined duration during which the position will belong to a purchasing advertiser. A database is operable to store a plurality of fixed position listings in addition to advertising content related thereto. A processor is coupled with the fixed position offeror and the database. The processor is operable to reserve the fixed position related to the keyword for the pre-defined duration for the advertiser; receive an advertisement from the advertiser to be positioned in the fixed position; store the advertisement in the database; and serve the advertisement to the fixed position of the search results web page in response to a search query for the keyword each time the search query is executed for the keyword over a time period of the pre-defined duration.

In a seventh aspect, a system is disclosed for reserving sponsored search listing positions, including a fixed position offeror operable to extend an offer to advertisers to purchase a predetermined number of fixed sponsored search listing positions on a search results web page affiliated with a keyword. A location of each fixed position is guaranteed to the advertisers for a fixed fee over a pre-defined duration during which each position belongs to advertisers that accept the offer. A database is operable to store a plurality of fixed position listings in addition to advertising content related thereto. A processor is coupled with the fixed position offeror and the database, and is operable to: reserve the fixed position related to the keyword for the pre-defined duration for an advertiser upon acceptance of the offer by the advertiser; receive an advertisement from the advertiser to be positioned in the fixed position; and provide a call-back feature associated with the advertisement of at least a highest-ranked fixed position, wherein upon a user engaging the feature, causes a pop-up window in the web page to accept a contact phone number from the user for the advertiser to call as a way to follow up on a lead provided by the user.

In an eight aspect, a system is disclosed for reserving sponsored search listing positions, including a fixed position offeror operable to receive a request from advertisers to reserve a fixed sponsored listing position within search listing categories for a pre-defined duration of time and a flat fee. A plurality of related keywords are associated with each category, and a plurality of fixed positions are available for each category. The fixed position offeror is operable to check availability of a fixed position within a category for an interested advertiser, and to reserve the fixed position for the category, if available, for the advertiser for the pre-defined duration of time. A database operable to store a plurality of fixed position listings in addition to advertising content related thereto. A processor is coupled with the fixed position offeror and the database, and is operable to: receive an advertisement from the advertiser to be located in the fixed position for each of at least some of the keywords; store the advertisements in the database; and serve an advertisement to the fixed position on a search results web page in response to a search query for one of the plurality of keywords each time the search query is executed during the pre-defined duration of time.

In a ninth aspect, a system is disclosed for serving sponsored advertisements together with fixed-position advertisements, including a search engine operable to receive data from an advertising server including a list of fixed-position, fixed-price, and fixed-duration sponsored advertisements purchased by advertisers for a keyword, a category of keywords, or combinations thereof. A processor is coupled with the search engine, the processor operable to aggregate the list of fixed-position advertisements together with a plurality of sponsored search advertisements for the keyword, category of keywords, or combinations thereof such that the fixed-position advertisements will be served to the correct fixed positions among a plurality of sponsored search positions. A search results generator is coupled with the search engine and the processor, the search results generator operable to receive a query from a user for one of the keywords and to serve to a search results web page of the user the plurality of fixed-position sponsored advertisements to their respective fixed positions, and to serve the plurality of search sponsored advertisements to one or more remaining available sponsored search positions.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary system for reserving sponsored listing positions in a fixed position on a web page for a fixed price over a predetermined, fixed duration of time.

FIG. 2 is a screen shot displaying a search results page, including sponsored, fixed-position advertising positions.

FIG. 3 is a screen shot displaying a pop-up window of the advertisement filling the highest-ranked, fixed-position advertising position of FIG. 2, together with a call-back feature.

FIG. 4 is a flow chart of an exemplary method for reserving sponsored listing positions in a fixed position on a web page for a fixed price over a fixed duration of time.

FIG. 5 is a flow chart of another embodiment of a method for reserving sponsored listing positions in a fixed position on a web page for a fixed price over a fixed duration of time, the method including providing a call-back feature.

FIG. 6 is a flow chart of an exemplary method for reserving sponsored listings positions in a fixed position on a web page for a fixed price over a fixed duration of time, wherein categories of keywords are purchasable.

FIG. 7 is a flow chart of an exemplary method for reserving sponsored listings positions in a fixed position on a web page for a fixed price over a fixed duration of time, wherein the web page includes one of content match or domain match sponsored advertising results.

FIG. 8 is a flow chart of a method for serving sponsored advertisements together with fixed-position advertisements.

### DETAILED DESCRIPTION

By way of introduction, the disclosed embodiments relate to systems and methods of offering for reservation fixed-position sponsored search listings for a fixed fee and for a fixed or pre-defined duration of time. Accordingly, the disadvantages of pay-per-click (PPC) advertising are avoided, as is the improper valuation of tail terms as discussed above.

Bidding on tail terms is a “long tail” approach to advertising in which advertisers tap into a new paradigm of retail behavior that is more targeted, and cost-effective. Typically, the long tail approach includes two or more keywords, especially where one word is too broad and usually more expensive to bid on in the PPC context. For this same reason, tail terms are usually more targeted because they are narrower and more closely define the product or service being offered. Accordingly, tail terms contain more information about the query, and thus are more apt to directly meet the needs of the user. When matched with highly relevant creative messaging and landing pages that provide a direct path to conversion, the result is an ad experience completely customized to the user. This usually equals more conversions and better brand stickiness. Tail terms also may help advertisers speak to their audience in a market void of competitive pressures. Such terms cost less than more popular keywords subject to bid inflation and though typically low in volume, their stronger conversion rates mean more value per marketing dollar.

Combining the use of tail terms with the need of small business owners (or any business owner) with a tight budget or a concern with return on investment (ROI), the offering a fixed price for a keyword term may be attractive for various reasons. Better than just a fixed price, perhaps, is to offer a fixed position in a list of sponsored advertisements for a predetermined period of time and for the fixed price. Accordingly, an advertiser may outright purchase that position for a predictable price over a known period of time, therefore meeting both its need to advertise and its need to operate within a fixed advertising budget. The fixed position over a fixed period of time may also make more predictable an expected ROI. Where an advertiser broker offers such fixed price, position, and duration advertisements, the advertiser broker also benefits economically by being able to set a competitive value to each term at its fixed position and duration, and sell the same for an amount that would be more than if the same term were auctioned through a PPC bidding process. An advertising “broker” refers to an entity that acts as a go-between publishers and advertisers to deliver ad content sponsored by the latter to Web pages of publishers. Examples of advertiser brokers include Yahoo! of Sunnyvale, Calif. and Google of Mountain View, Calif.

While tail terms are explained as keyword terms of special interest, other pre-defined keywords may be eligible for fixed-position, fixed-duration purchase at a fixed price depending on other factors of interest. Some of those factors may include the targeted advertisers and their level of interest in purchasing such keyword terms for a fixed price.

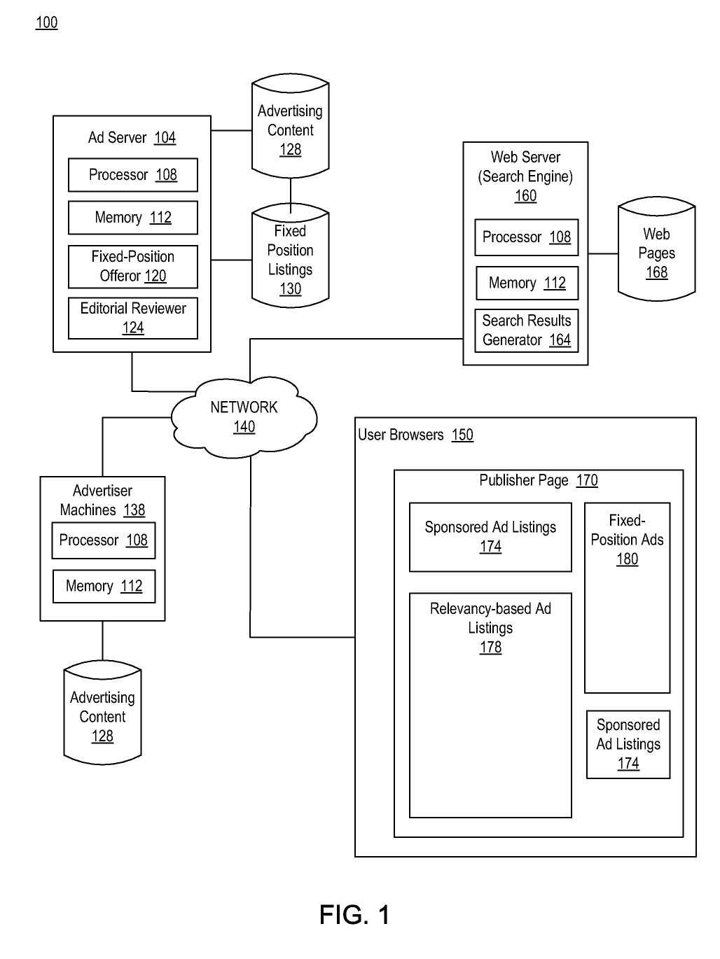

FIG. 1 is a diagram of an exemplary system 100 for reserving sponsored listing positions in a fixed position on a Web page for a fixed price over a predetermined, fixed duration of time. The system 100 includes an ad server 104, which may in turn include: a processor 108, a memory 112, a fixed position offeror 120, an editorial reviewer 124, an advertising content database 128, and a fixed-position listings database 130. The system 100 also includes advertiser machines 134 that communicate over a network 140 and that may also contain a processor 108, a memory 112, and an advertising content database 128. The system 100 likewise includes user browsers 150 of users of the internet or other local or world-wide network that serves sponsored advertising with Web pages and search results. The system 100 also includes a Web server 160 that delivers Web pages to the user browsers 150, including a publisher page 170. The Web server 160 may also include a processor 108, a memory 112, a search results generator 164, and a Web pages database 168 and may additionally function as a search engine in some embodiments. The publisher page 170 may include sponsored advertisement (“ad”) listings 174, relevancy-based ad listings 178, and a number of fixed-position advertisements 180.

The network 140 may include the internet or World Wide Web (“Web”), a wide area network (WAN), a local area network (“LAN”), and/or an extranet, connected to through use of either a wired or wireless connection. The ad server 104 may deliver advertisements that include advertising content from the advertising content database 128 for integration with the publisher page 170 delivered by the Web server 160. The Web server 160 may include any computing device used by an advertiser broker or publisher to deliver Web page content or search engine search results to the user browsers 150. Furthermore, the publisher page 170 that is populated with Web page content by the Web server 160 may also be populated with advertising content delivered by the ad server 104.

The Web page content and advertising content may be integrated together before being delivered to the user browsers 150. In this case, advertisements may be stored in the Web pages database 168 in relation to the Web pages with which they are to be delivered. In the alterative, the Web pages from the Web pages database 168 are delivered to the user browsers 150 upon request by the user browsers 150, and various advertisement listings are then delivered (or “served”) by the ad server 104 to the Web pages for substantially simultaneous viewing by users. When an advertisement or advertisement listing is engaged, the user browser 150 may be redirected, or launch a new window or tab, to deliver the actual landing page of the advertisement, which may be a home page of the advertiser.

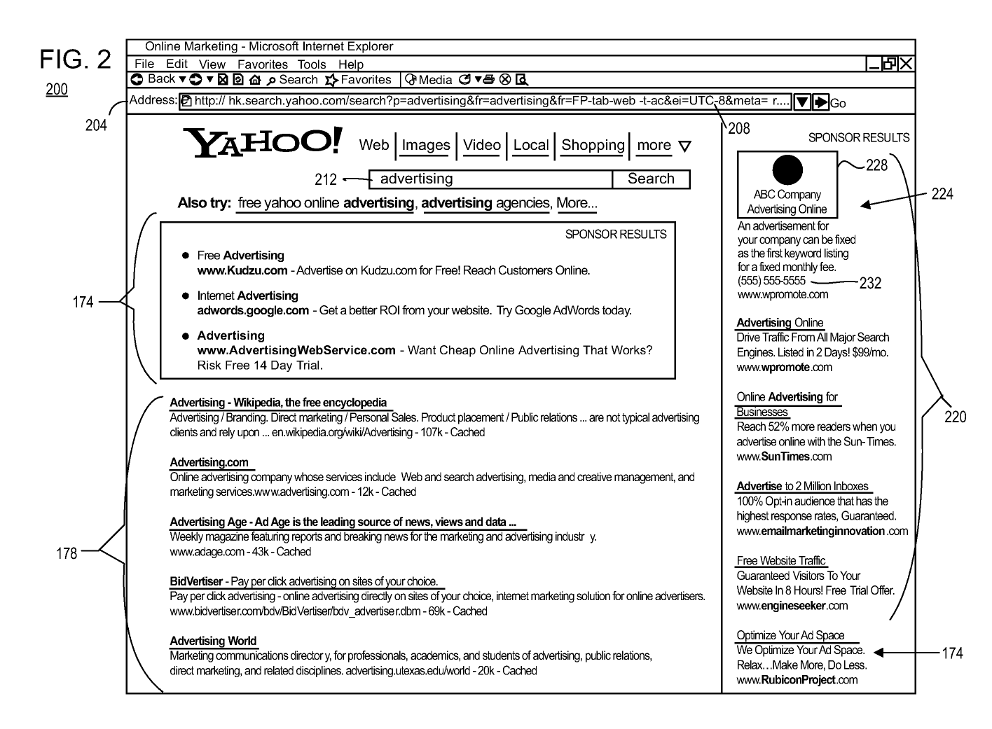

In some cases, the publisher page 170 may be a search results page delivered in response to a user query of a search engine 160 for a keyword. The search results generator 164 reacts to a search query submitted by an internet searching user, and produces a search results list to be displayed in the Web browser 150 for user selection such as the relevancy-based ad listings 178. (See also FIG. 2.) Each listed advertisement usually includes a title, a short description, and a link to a corresponding advertiser Web page, e.g., a uniform resource locators (URL), which listing is stored in the advertising content database 128 and/or the Web pages database 164. The search results generator 164 may attempt to list the search results so that the most relevant search results, in relation to the query, are listed first. Included on a part of the publisher page 170, usually in the cardinal north, east, and south directions, are located sponsored ad listings 174. As discussed previously, the sponsored ad listings 174 are those paid for by advertisers on a pay-per-click (PPC) basis for keywords contained in the query. The higher-positioned (or ranked) of these sponsored ad listings are those for which the advertisers are paying the most per click. Accordingly, the position of a sponsored advertisement 174 on the publisher page 170 is numbered sequentially, each of which will be variably referred to herein as a “slot.”

In the present embodiments, at least a predetermined number of the sponsored ad listing 174 positions are offered to advertisers as fixed-position advertisements 180, for which the advertisers are guaranteed the position over the duration of the offered position if they pay a fixed price. For instance, the first four to six (or some other number) of the positions in the cardinal east direction may be offered as fixed-position locations or slots. The way this offer is formulated and extended to the advertisers may vary, and accordingly, the fixed position offeror 120 is configured within the ad server 104 (or some other advertisement management server (not shown)) to formulate, extend, and/or negotiate such offers. Part of the negotiation process may occur with a live person, who could then access the fixed position offeror 120 through a user interface (not shown) to set the offered price that the advertiser could then accept. Accordingly, when the fixed position offeror 120 is referred to herein, it may include at least in part a live person that may directly negotiate with advertisers. The advertiser may accept an offer by paying the fixed fee or price online, over the phone, agreeing to be billed, or any other number of ways apparent to skilled persons.

Once one or more advertisers accept such offers, and the terms of the agreements formed, the advertisers may upload from their machines 138 the advertising content to be served to the fixed position(s). The terms of these agreements—such as the advertiser identity, the keywords, the fixed position, and the duration—together with associated uploaded advertisements may all be saved in the fixed position listings database 130. The fixed-position listings database 130 may be integrated or coupled with the advertising content database 128. Herein, the phrase “coupled with” is defined to mean directly connected to or indirectly connected through one or more intermediate components.

In alternative embodiments, the offers for fixed-position advertisements 180 may be according to category of keywords. Advertisers who secure such fixed-position agreements purchase a category and a fixed position for a fixed or pre-defined duration of time. Various keyword terms are then pre-defined for each category. For instance, the category “portable computing” may include keywords related to portable computer equipment such as personal digital assistants (PDA's), laptop computers, cell phones, other mobile devices, and/or associated software designed for use in such portable computer equipment. Each keyword term or phrase may be, a priori, defined as belonging to the “portable computing” category. This will allow for offering and selling groups of keywords for all of which a purchasing advertiser will secure fixed positions in response to queries including those keywords. An increased premium may be charged advertisers that purchase such agreements, which include a category and fixed position. In any of the embodiments disclosed herein, a premium may also be charged for the highest-ranked position as it may typically attract a higher percentage of the click traffic when compared with lower-ranked positions.

Various ways of offering fixed-positions for online advertisements may include doing so on a first-come, first-served basis, through a negotiation process, or through a historical process that fixes initial prices based on past PPC prices. The offered fixed-positions may be for tail terms or for other types of keyword terms based on defined criteria deemed important to the commercialization of the keyword terms by advertiser brokers or publishers. Whatever method is used, the brokers or publishers may use an algorithmic approach to determine the value of the term at a fixed-price, position, and duration in the marketplace, and then use that value on which to base the requested fixed-price or “flat-fee.” These flat-fee, fixed-position agreements may be renewable after the fixed-duration time period has ended, subject to interest by other advertisers that want to purchase the keyword terms for the next time period of fixed-duration.

The offeror 120, in some embodiments, may enable more than one advertiser to enter a bidding battle to allow multiple advertisers to set a market value for the fixed-positions through bidding, especially for the highest-ranked of the fixed-positions. Accordingly, the system 100 may allow bidding in some cases for the fixed-position advertisements 180 where there is a higher demand than is usual for tail terms, and where such bidding will facilitate setting a proper market value for the fixed-position, fixed-duration advertisement 180 slots. The highest-bidding advertiser may be allowed to purchase the fixed-position slot on which the advertiser bid. After setting an initial fixed-fee for such a fixed-position advertisement, bidding may only be required periodically thereafter for such keyword terms when needed to update their market value after the passage of time. The system 100 may also be configured to force sharing the highest-listed, fixed-positioned advertisement 180, such that multiple advertisers that desire the same fixed-positioned advertisement 180 may rotate through ownership of the same. In the alternative, ownership of a fixed-position advertisement 180 may be grandfathered such that, as long as a periodic payment is made before the end of each fixed-duration time period, the advertiser retains such ownership.

The optimal positions for advertisements may also vary, and may be a subjective determination. In other words, the most optimal position may differ for different keywords or categories of keywords based on advertiser interest, e.g., on market demand. Accordingly, the highest position may not be the most demanded and some other fixed-position location will be given premium treatment based on it drawing more interest. The publisher page 170, therefore, may be a web page that includes a set of available fixed advertising positions that are ordered or ranked according to their desirability. This way, it does not matter where the fixed-position advertisements 180 are located throughout the sponsored ad listings 174, just that some of the positions are more desired by advertisers. The desirability assessment may further be used to place a fixed-price on one or more of the fixed-positions, which fixed-price may then be used by the fixed-position offeror 120 in offering to advertisers the fixed-position for purchase.

In similar fashion, the time period set as the fixed or pre-defined duration may be variable, and the advertiser may choose whatever suits him or her best, e.g., only weekends, only weekdays, the first of every month, the end of every month, two days on and three days off, etc. Depending on the time period chosen as the fixed duration, the fixed-price available for the fixed-position may be adjusted by the fixed-position offeror 120.

In other cases, sponsored ad listings 174 that include at least a mixture of a predetermined number of fixed position advertisements 180, may also be served in response to content match and/or domain match types of sponsored ad listings 174. In other words, the publisher page 170 may be a Web page delivered to the user browsers 150 in response to user browsing that triggers content match and/or domain match types of sponsored ad listings 174. Content match includes serving sponsored ad listings 174 to any Web page based on the keyword terms or other content found in that Web page. Content match sponsored ad listings 174 are typically located at the cardinal east location of the publisher page 170.

Domain match includes serving sponsored ad listings 174 to a Web page reached by a browsing user that types in a domain name into a URL find box that matches the purchased keyword term(s). The matched domain names (URLs) are usually wrongly-entered or misspelled versions of another domain name owned by a third party publisher or by the advertiser broker. A domain match results page may look the same or similar to a search results page, and accordingly, all that was discussed above with reference to search results pages applies to a domain match page as well, to which fixed-position, fixed-price, and fixed-duration advertisements may also be served.

After an advertiser initiates interest in a particular keyword or category of keywords, to include a domain name keyword, the ad server 104 may check the fixed-position listings database 130 for availability of the particular keyword or category of keywords. If available and according to the terms of the offer or negotiation, the ad server 104 reserves the keyword or category of keywords for the fixed duration at the fixed-position for an advertiser after by the advertiser, e.g., upon paying or agreeing to pay the fixed or flat fee.

The ad server 104 may request and then receive from the advertiser machine 138 an advertisement and, in some case, additional advertising content, which will be discussed later. The advertising content is saved in the database 128 and also output (if required) to the publisher or broker for review. The editorial reviewer 124 reviews the advertisements and related content uploaded by purchasing advertisers over the network 140, and may be located at the ad server 104 or at another location such as at the advertisement management server (not shown). The editorial reviewer 124 is an automated version of an advertising content reviewer to ensure compliance with content rules, e.g., to ensure there is no adult, trademarked, copyrighted, or other disallowed content. A manual review may also be executed by a live editor. The editorial reviewer 124 (and/or the manual editor) may then either approve or reject the advertisement and related content for publishing. The ad server 104 (or advertisement management server) may, subsequently, allow the advertiser of any rejected content to rework the advertisement and related content and resubmit the same for further review, in the hopes to overcome the reasons for rejection.

Every so often, such as once a day or once an hour, the updated fixed position listings database 130 may be exported as a database or text file (or other file) to publishers such as those that own or operate web servers 160. The web server 160, which may include or be communication with a search engine (not shown), may then aggregate the fixed-position listings database 130 with a plurality of sponsored ad listings 174 according to what slots or positions have been purchased. In this way, the publisher page 170 containing search query results, a content match, or a domain name match may display both the PPC or regular sponsored ad listings 174 and the fixed position advertisements 180 simultaneously and in compliance with purchased fixed positions. Whatever sponsored ad listing 174 slots are not filled with purchased fixed-position ads 180 may be filled in with sponsored ad listings 174.

FIG. 2 is a screen shot 200 displaying a search results page 204. The search results page 204 may include a web address bar 208, a query or search bar 212, and a plurality of fixed-position, sponsored advertising positions 220. The search results page 204, as discussed with reference to the publisher page 170 of FIG. 1 may also include relevancy-based ad listings 178 (organic results) and sponsored ad listings 174 (e.g., PPC search listings). The fixed-position advertising positions 220 may take up a predetermined number of the previously-occupied positions for the sponsored ad listings 174. In FIG. 2, for instance, they take up the first five positions. In alternative embodiments, one or more fixed-position advertisements 180 may take up any number and combination of positions to provide the fixed-position advertising positions 220 in the search results page 204. Any positions not reserved by the system 100 as fixed-position advertising positions 220 may be filled with regular PPC sponsored ad listings 174.

As displayed, the fixed-position advertising positions 220 may include a highest-ranked, fixed-position advertising position 224, the remainder being lower-ranked, fixed-position advertising positions. At least the highest-ranked, fixed-position advertising position 224 may include additional features, for instance, by virtue of the advertiser being expected to pay a premium for that position. For instance, the additional features may include, but are not limited to: an image 228, which may be hyperlinked as the URL is hyperlinked, and a telephone contact number 232 for the advertiser.

When a user enters a keyword search term in the query bar 212 and executes a search, the search results page 204 is generated to return results of at least three types: (1) relevancy-based ad listings 178, search sponsored ad listings 174, and fixed-position ad listings 180. Listings of each of these three types of advertisements are displayed in FIG. 2 by example only.

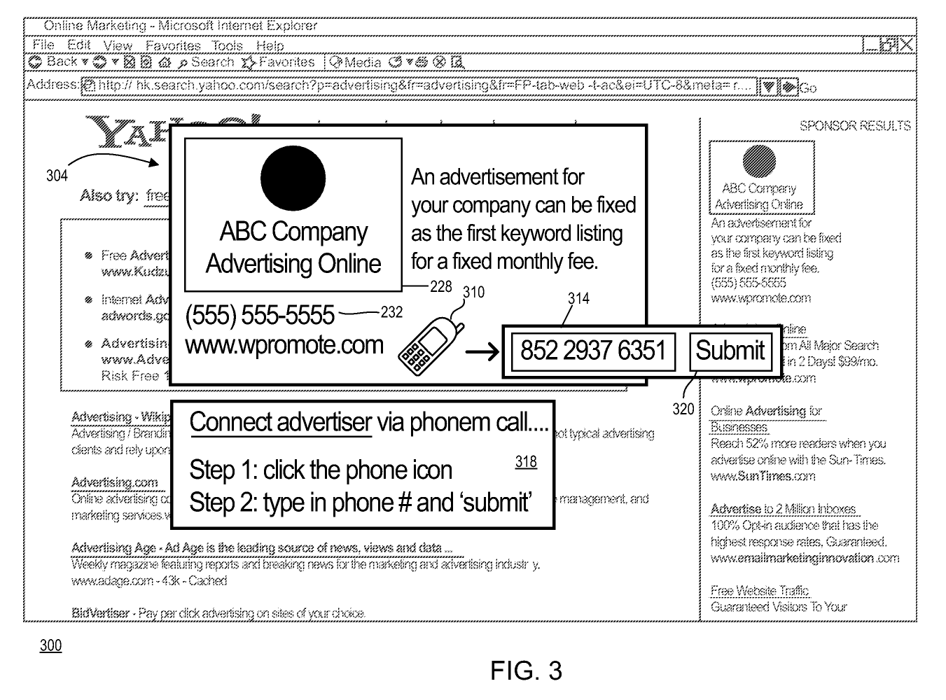

FIG. 3 is a screen shot 300 displaying a pop-up window 304 of the advertisement in the highest-ranked, fixed-position advertising positions 224 of FIG. 2. When a cursor, pointer, or other input indicia is dragged over or engages the image 232 displayed in FIG. 2, the pop-up window 304 is launched by the search results page 204. In the pop-up window 304 is displayed an enlarged version of the highest-ranked, fixed-position ad 224 substantially as displayed on the search results page 204. An additional feature that may be included includes a call back feature 310 (shown in FIG. 3 as a telephone icon), which when selected, launches a second pop-up window 314 to accept a phone number. An explanation window 318 may also appear that explains how to activate and use the call-back feature 310.

The user may then type in his or her contact phone number into the second pop-up window 314 and select a submit button 320. Once submitted, the call-back number of the user is sent directly to the advertiser that owns the highest-rank, fixed-position advertising position 224. The received phone number acts as a lead, indicating to the advertiser that the advertiser is free to call the user to determine the user's interest in the subject matter of the fixed-position advertisement. While FIG. 3 displays the call-back feature 310 as associated with only the highest-ranked, fixed-position advertising position 224, alternative embodiments may include the call-back feature 310 for some or all of the fixed-position advertising positions 220.

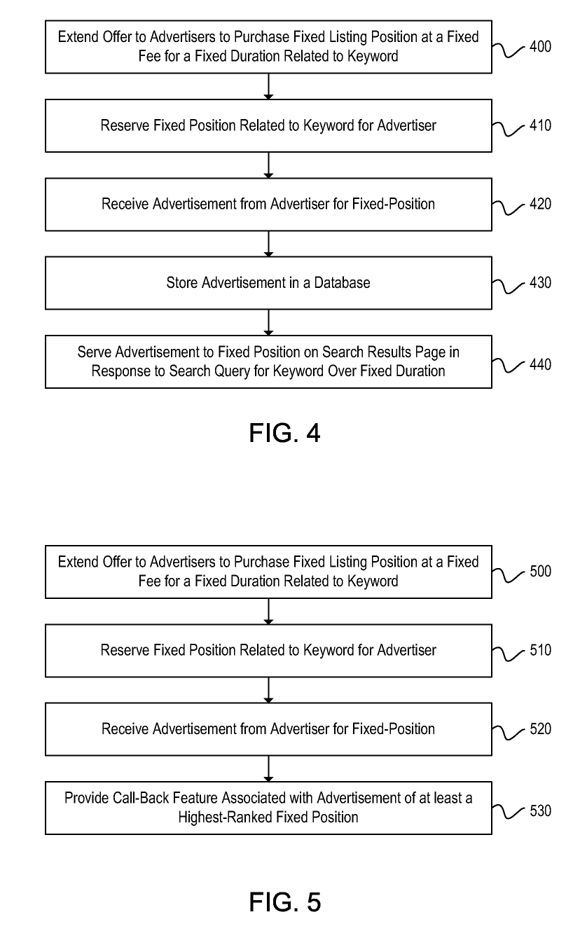

FIG. 4 is a flow chart of an exemplary method for reserving sponsored listing positions in a fixed position on a web page for a fixed price over a fixed duration of time. The method, at block 400, extends an offer to advertisers to purchase a fixed sponsored search listing position on a search results web page affiliated with a keyword, wherein a location of the fixed position is guaranteed to the advertisers for a fixed fee over a fixed duration during which the position will belong to a purchasing advertiser. At block 410, it reserves the fixed position related to the keyword for the fixed duration for an advertiser. At block 420, it receives an advertisement from the advertiser to be positioned in the fixed position. At block 430, it stores the advertisement in a database. At block 440, it serves the advertisement to the fixed position of the search results web page in response to a search query for the keyword each time the search query is executed for the keyword over a time period of the fixed duration.

FIG. 5 is a flow chart of another embodiment of a method for reserving sponsored listing positions in a fixed position on a web page for a fixed price over a fixed duration of time, including providing a call-back feature. The method, at block 500, extends an offer to advertisers to purchase a predetermined number of fixed sponsored search listing positions on a search results web page affiliated with a keyword, wherein a location of each fixed position is guaranteed to the advertisers for a fixed fee over a pre-defined duration during which each position belongs to purchasing advertisers. At block 510, it reserves the fixed position related to the keyword for the fixed duration for an advertiser upon acceptance of the offer by the advertiser. At block 520, it receives an advertisement from the advertiser to be positioned in the fixed position. At block 530, it provides a call-back feature associated with the advertisement of at least a highest-ranked fixed position, wherein upon a user engaging the feature, it causes a pop-up window in the web page to accept a contact phone number of the user for the advertiser to call as a way to follow up on a lead provided by the user.

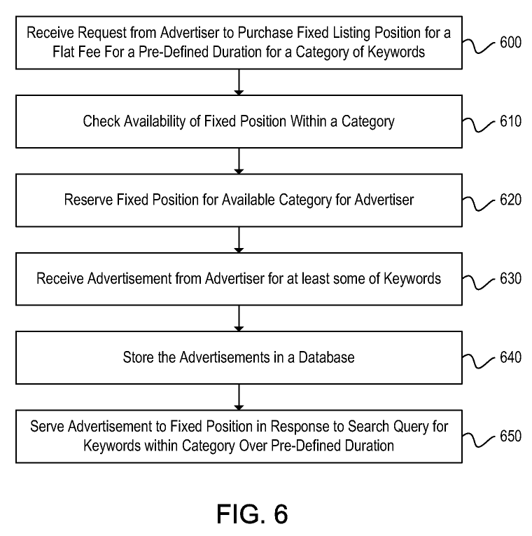

FIG. 6 is a flow chart of an exemplary method for reserving sponsored listings positions in a fixed position on a web page for a fixed price over a fixed duration of time, wherein categories of keywords are purchasable. The method, at block 600, receives a request from advertisers to purchase a fixed sponsored listing position within search listing categories for a pre-defined duration of time and a flat fee. Multiple related keywords are associated with each category, wherein multiple fixed positions are available for each category. At block 610, it checks availability of a fixed position within a category for an interested advertiser. At block 620, it reserves the fixed position for the category, if available, for the advertiser for the pre-defined duration of time upon acceptance of the offer by the advertiser. At block 630, it receives an advertisement from the advertiser to be located in the fixed position for each of at least some of the multiple keywords. At block 640, it stores the advertisements in a database. At block 650, it serves an advertisement to the fixed position on a search results web page in response to a search query for a keyword of the plurality of keywords each time the search query is executed during the pre-defined duration of time.

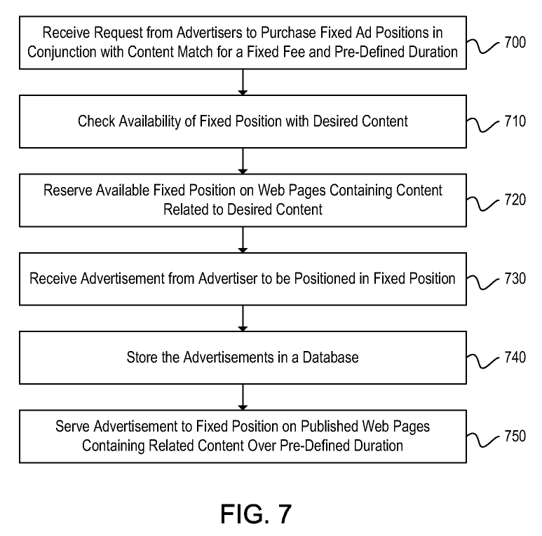

FIG. 7 is a flow chart of an exemplary method for reserving sponsored listings positions in a fixed position on a web page for a fixed price over a fixed duration of time, wherein the web page includes one of content match or domain match sponsored advertising results. The method, at block 700, receives a request from advertisers to purchase a predetermined number of fixed advertisement positions available in conjunction with content match on a published web page for a fixed fee and for a pre-defined duration of time. Content match is the service of sponsored advertisements to a published web page related to the content of the published web page. At block 710, the method checks position availability for a fixed position affiliated with desired content by an interested advertiser. At block 720, it reserves an available, fixed position related to content of interest to the advertiser for the pre-defined duration of time. At block 730, it receives an advertisement from the advertiser to be positioned in the fixed position. At block 740, it stores the advertisement in a database. At block 750, it serves the advertisement to the fixed position on the published web page containing related content each time a user browses to the published web page during the pre-defined duration of time.

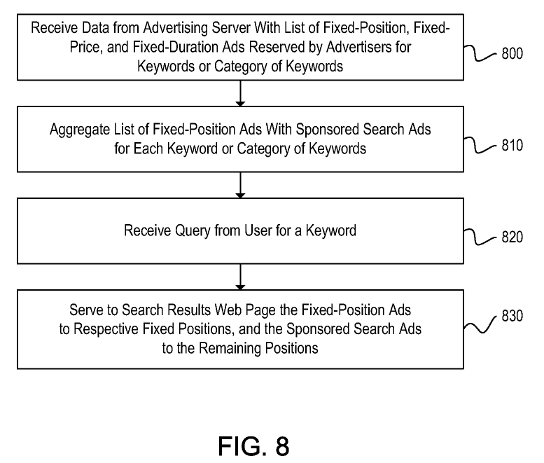

FIG. 8 is a flow chart of a method for serving sponsored advertisements together with fixed-position advertisements. The method, at block 800, receives data from an advertising server including a list of fixed-position, fixed-price, and fixed-duration sponsored advertisements reserved by advertisers for a given keyword, category of keywords, or combinations thereof. At block 810, it aggregates the list of fixed-position advertisements together with a plurality of sponsored search advertisements for the keyword, category of keywords, or combinations thereof such that the fixed-position advertisements will be served to the correct fixed positions among multiple sponsored search positions. At block 820, it receives a query from a user for one of the keywords. At block 830, it serves to a search results web page of the user the plurality of fixed-position sponsored advertisements to their respective fixed positions, and the plurality of search sponsored advertisements to one or more remaining available sponsored search positions.

In the foregoing description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A method for reservation of sponsored search listing positions, the method comprising:
extending an offer to advertisers to purchase a fixed sponsored search listing position on a search results web page affiliated with a keyword, wherein a location of the fixed position is guaranteed to the advertisers for a fixed fee over a fixed duration during which the position will belong to a purchasing advertiser;
reserving the fixed position related to the keyword for the fixed duration for an advertiser;
receiving an advertisement from the advertiser to be positioned in the fixed position;
storing the advertisement in a database; and
serving the advertisement to the fixed position of the search results web page in response to a search query for the keyword each time the search query is executed for the keyword over a time period of the fixed duration.

2. The method of claim 1, wherein a predetermined number of fixed positions fewer than a total number of available sponsored search listing positions are offered for purchase, the method further comprising:
checking keyword availability for an interested advertiser, wherein only pre-defined keywords are available for purchase at a fixed position on the search results web page; and
checking position availability for a fixed position affiliated with an available keyword that is desired by the interested advertiser.

3. The method of claim 2, wherein reserving the fixed position is executed on a first-come, first-served basis to interested advertisers.

4. The method of claim 2, wherein extending the offer to advertisers to purchase the fixed position comprises offering the highest-ranked fixed position for a fixed premium fee, and the remainder of the predetermined fixed positions for a lower-priced fixed fee.

5. The method of claim 4, further comprising:
enabling bidding by the advertisers for purchase of the highest-ranked fixed position, wherein the highest-bidding advertiser is allowed to purchase the highest-ranked fixed position.

6. The method of claim 4, further comprising:
making available in the highest-ranked fixed position, in addition to the advertisement, one or more of an image and a contact telephone number of the advertiser.
receiving the one or more of the image and the contact telephone number with the advertisement from the advertiser that secures the highest-ranked fixed position; and
serving the one or more of the image and the contact telephone number with the advertisement into the highest-ranked fixed position in response to a query for the keyword during the time period of the fixed duration.

7. The method of claim 6, further comprising:
conducting an editorial review process to approve or reject the advertisement submitted by the advertiser, to include the one or more of the image and the contact telephone number if received from the highest-ranked, fixed-position advertiser; and
enabling the advertiser to resubmit advertising content if it is rejected.

8. A system for reservation of sponsored search listing positions, comprising:
a fixed position offeror operable to extend an offer to advertisers to purchase a fixed sponsored search listing position on a search results web page affiliated with a keyword, wherein a location of the fixed position is guaranteed to the advertisers for a fixed fee over a pre-defined duration during which the position will belong to a purchasing advertiser;
a database is operable to store a plurality of fixed position listings in addition to advertising content related thereto;
a processor coupled with the fixed position offeror and the database, wherein the processor is operable to:
reserve the fixed position related to the keyword for the pre-defined duration for the advertiser;
receive an advertisement from the advertiser to be positioned in the fixed position;
store the advertisement in the database; and
serve the advertisement to the fixed position of the search results web page in response to a search query for the keyword each time the search query is executed for the keyword over a time period of the pre-defined duration.

9. The system of claim 8, wherein the fixed position offeror offers a predetermined number of fixed positions fewer than a total number of available sponsored search listing positions, wherein the processor is operable to:
check keyword availability for an interested advertiser, wherein only pre-defined keywords are available for purchase at a fixed position on the search results web page; and
check position availability for a fixed position affiliated with an available keyword that is desired by the interested advertiser.

10. The system of claim 9, wherein reserving the fixed position is executed on a first-come, first-served basis to interested advertisers.

11. The system of claim 9, wherein the fixed position offeror is operable to:
offer to advertisers a highest-ranked fixed position for a fixed premium fee; and
offer the remainder of the predetermined fixed positions for a lower-priced fixed fee.

12. The system of claim 11, where the fixed position offeror is operable to enable bidding by the advertisers for purchase of the highest-ranked fixed position, wherein the highest-bidding advertiser is allowed to purchase the highest-ranked fixed position.

13. The system of claim 12, wherein the processor is operable to:
receive one or more of an image and contact telephone number with the advertisement from the advertiser that secures the highest-ranked fixed position; and
serve the one or more of the image and the contact telephone number with the advertisement into the highest-ranked fixed position in response to a query for the keyword during the time period of the fixed duration.

14. The system of claim 13, wherein the processor is operable to:
enable resubmission of the advertisement, in addition to the one of the image and the contact telephone number, if the content thereof is rejected by an editor.

15. A method for reservation of sponsored search listing positions, the method comprising:
extending an offer to advertisers to purchase a predetermined number of fixed sponsored search listing positions on a search results web page affiliated with a keyword, wherein a location of each fixed position is guaranteed to the advertisers for a fixed fee over a pre-defined duration during which each position belongs to purchasing advertisers;
reserving the fixed position related to the keyword for the fixed duration for an advertiser upon acceptance of the offer by the advertiser;
receiving an advertisement from the advertiser to be positioned in the fixed position; and
providing a call-back feature associated with the advertisement of at least a highest-ranked fixed position, wherein upon a user engaging the feature, causing a pop-up window in the web page to accept a contact phone number from the user for the advertiser to call as a way to follow up on a lead provided by the user.

16. The method of claim 15, wherein the highest-ranked of the fixed positions is offered for a fixed premium fee, and the remainder thereof are offered for a lower-priced fixed fee, the method further comprising:
serving the advertisement to the fixed position of the search results web page in response to a search query for the keyword each time the search query is executed for the keyword over a time period of the pre-defined duration.

17. The method of claim 15, further comprising:
receiving, for the highest-ranked fixed position and in conjunction with the advertisement, one or more of an image and a contact telephone number of the advertiser; and
serving the advertisement, together with the one or more of the image and the contact telephone number, to the highest-ranked fixed position each time the search query is executed for the keyword over a time period of the pre-defined duration.

18. The method of claim 15, further comprising:
conducting a negotiation process with the advertiser to negotiate the fixed fee before payment thereof by the advertiser.

19. A method for reservation of sponsored search listing positions, the method comprising:
receiving a request from advertisers to purchase a fixed sponsored listing position within search listing categories for a pre-defined duration of time and a flat fee, wherein a plurality of related keywords are associated with each category, and wherein a plurality of fixed positions are available for each category;
checking availability of a fixed position within a category for an interested advertiser;
reserving the fixed position for the category, if available, for the advertiser for the pre-defined duration of time upon acceptance of the offer by the advertiser;
receiving an advertisement from the advertiser to be located in the fixed position for each of at least some of the plurality of keywords;
storing the advertisements in a database; and
serving an advertisement to the fixed position on a search results web page in response to a search query for a keyword of the plurality of keywords each time the search query is executed during the pre-defined duration of time.

20. The method of claim 19, wherein the plurality of fixed positions are located on the search results web page within or proximate to other sponsored search listings offered through a pay-per-click bidding process.

21. The method of claim 19, wherein reserving the fixed position upon request by the advertiser is executed on a first-come, first-served basis.

22. The method of claim 19, wherein extending the offer to advertisers to purchase the fixed position comprises offering the highest-ranked fixed position for a flat premium fee, and the remainder of the plurality of fixed positions for a lower-priced flat fee.

23. The method of claim 22, further comprising:
enabling bidding by the advertisers for purchase of the highest-ranked fixed position, wherein the highest-bidding advertiser is allowed to purchase the highest-ranked fixed position.

24. A method for reservation of sponsored search listing positions, the method comprising:
receiving a request from advertisers to purchase a predetermined number of fixed advertisement positions available in conjunction with content match on a published web page for a fixed fee and for a pre-defined duration of time, wherein content match is the service of sponsored advertisements to a published web page related to the content of the published web page;
checking position availability for a fixed position affiliated with desired content by an interested advertiser;
reserving an available, fixed position related to content of interest to the advertiser for the pre-defined duration of time;
receiving an advertisement from the advertiser to be positioned in the fixed position;
storing the advertisement in a database; and
serving the advertisement to the fixed position on the published web page containing related content each time a user browses to the published web page during the pre-defined duration of time.

25. The method of claim 24, wherein content match comprises domain match, wherein domain match is the service of advertisements to a web page in response to users entering a domain name in a web address bar that matches a uniform resource locator (URL) of the web page.

26. The method of claim 25, wherein reserving a fixed position is executed on a first-come, first-served basis to interested advertisers.

27. A method for serving sponsored advertisements together with fixed-position advertisements, the method comprising:
receiving data from an advertising server including a list of fixed-position, fixed-price, and fixed-duration sponsored advertisements reserved by advertisers for a given keyword, category of keywords, or combinations thereof;
aggregating the list of fixed-position advertisements together with a plurality of sponsored search advertisements for the keyword, category of keywords, or combinations thereof such that the fixed-position advertisements will be served to the correct fixed positions among a plurality of sponsored search positions;
receiving a query from a user for one of the keywords; and
serving to a search results web page of the user the plurality of fixed-position sponsored advertisements to their respective fixed positions, and the plurality of search sponsored advertisements to one or more remaining available sponsored search positions.

28. The method of claim 27, further comprising:
periodically receiving the data with updates to the list of fixed-position sponsored advertisements; and
re-aggregating the updated list of fixed-position advertisements together with the plurality of sponsored search advertisements for the keyword, category of keywords, or combinations thereof.

29. A system for reservation of sponsored search listing positions, comprising:
a fixed position offeror operable to extend an offer to advertisers to purchase a predetermined number of fixed sponsored search listing positions on a search results web page affiliated with a keyword, wherein a location of each fixed position is guaranteed to the advertisers for a fixed fee over a pre-defined duration during which each position belongs to advertisers that accept the offer;
a database is operable to store a plurality of fixed position listings in addition to advertising content related thereto;
a processor coupled with the fixed position offeror and the database, wherein the processor is operable to:
reserve the fixed position related to the keyword for the pre-defined duration for an advertiser upon acceptance of the offer by the advertiser;
receive an advertisement from the advertiser to be positioned in the fixed position; and
provide a call-back feature associated with the advertisement of at least a highest-ranked fixed position, wherein upon a user engaging the feature, causes a pop-up window in the web page to accept a contact phone number fromrom the user for the advertiser to call as a way to follow up on a lead provided by the user.

30. The system of claim 29, wherein the fixed position offeror is operable to offer the highest-ranked of the fixed positions for a fixed premium fee, and the remainder thereof for a lower-priced fixed fee, wherein the processor is operable to:
serve the advertisement to the fixed position of the search results web page in response to a search query for the keyword each time the search query is executed for the keyword over a time period of the fixed duration.

31. The system of claim 30, wherein the processor is operable to:
receive one or more of an image and a contact telephone number from an advertiser that purchases the highest-ranked fixed position; and
serve the advertisement with the one or more of the image and the contact telephone number to the highest-ranked fixed position.

32. A system for reservation of sponsored search listing positions, comprising:
a fixed position offeror operable to receive a request from advertisers to reserve a fixed sponsored listing position within search listing categories for a pre-defined duration of time and a flat fee, wherein a plurality of related keywords are associated with each category, and wherein a plurality of fixed positions are available for each category;
wherein the fixed position offeror is operable to check availability of a fixed position within a category for an interested advertiser, and to reserve the fixed position for the category, if available, for the advertiser for the pre-defined duration of time;
a database operable to store a plurality of fixed position listings in addition to advertising content related thereto; and
a processor coupled with the fixed position offeror and the database, wherein the processor is operable to:
receive an advertisement from the advertiser to be located in the fixed position for each of at least some of the plurality of keywords;
store the advertisements in the database; and
serve an advertisement to the fixed position on a search results web page in response to a search query for a keyword of the plurality of keywords each time the search query is executed during the pre-defined duration of time.

33. The system of claim 32, wherein the plurality of fixed positions are located on the search results web page within or proximate to other sponsored search listings offered through a pay-per-click bidding process.

34. The system of claim 32, wherein the fixed position offeror is operable to:
reserve the fixed position upon payment of the flat fee on a first-come, first-served basis; and
negotiate for an economic value of the flat fee at the fixed position for the fixed duration with the advertiser.

35. A system for serving sponsored advertisements together with fixed-position advertisements, the system comprising:
a search engine operable to receive data from an advertising server including a list of fixed-position, fixed-price, and fixed-duration sponsored advertisements purchased by advertisers for a keyword, a category of keywords, or combinations thereof;
a processor coupled with the search engine, the processor operable to aggregate the list of fixed-position advertisements together with a plurality of sponsored search advertisements for the keyword, category of keywords, or combinations thereof such that the fixed-position advertisements will be served to the correct fixed positions among a plurality of sponsored search positions; and
a search results generator coupled with the search engine and the processor, the search results generator operable to receive a query from a user for one of the keywords and to serve to a search results web page of the user the plurality of fixed-position sponsored advertisements to their respective fixed positions, and to serve the plurality of search sponsored advertisements to one or more remaining available sponsored search positions.

36. A system for serving sponsored advertisements together with fixed-position advertisements, the system comprising:
means for receiving data from an advertising server including a list of fixed-position, fixed-price, and fixed-duration sponsored advertisements reserved by advertisers for a given keyword, category of keywords, or combinations thereof;
means for aggregating the list of fixed-position advertisements together with a plurality of sponsored search advertisements for the keyword, category of keywords, or combinations thereof such that the fixed-position advertisements will be served to the correct fixed positions among a plurality of sponsored search positions;
means for receiving a query from a user for one of the keywords; and
means for serving to a search results web page of the user the plurality of fixed-position sponsored advertisements to their respective fixed positions, and the plurality of search sponsored advertisements to one or more remaining available sponsored search positions.
